(19) United States
(12) Patent Application Publication
(10) Pub. No.: US 2007/0000360 A1
(43) Pub. Date: Jan. 4, 2007

(54) Tool for an automobile brake lathe

(76) Inventors: Nicholas J. Colarelli III, St. Louis, MO (US); Michael D. Gerdes, St. Peters, MO (US); Michael A. Olsen, Lake St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/173,682

(22) Filed: Jul. 1, 2005

(51) Int. Cl. B23B 5/04

(52) U.S. Cl. 82/112

(57) ABSTRACT

A cutting tool for a brake lathe for machining automobile brake rotors including an adjustable cutting head. The cutting tool defines a first side and an opposite, second side. The cutting tool also defines a first end and a second end. The first side adjacent the first end defines a mounting surface for removable mounting a first cutting tip. The first side adjacent the second end also defines a mounting surface for removably mounting a second cutting tip. The cutting tool is configured to be mounted in the adjustable head such that the first cutting tip is positioned to machine the automobile brake rotor or the cutting tool may be mounted such that that second cutting tip is positioned to machine the automobile brake rotor.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates to automotive vehicle brake lathes configured for resurfacing brake rotor and drum components, and in particular to automotive vehicle brake lathes utilizing cutting tool holders capable of holding multiple inserts.

One of the main components of a vehicle wheel braking system employing disk brakes are the brake disks, or brake rotors, which provide a solid rotating surface against which the stationary brake friction pads are clamped or compressed to generate a frictional force, slowing the rotational movement of the brake disks or brake rotors and the associated vehicle wheels. The brake disks or brake rotors are subjected to repeated and substantial frictional forces by the brake friction pads, and over time, become worn. Uneven application of braking force, debris, or uneven frictional surfaces on the brake friction pads can result in the formation of grooves, channels, or scratches in the surfaces of the brake disks or brake rotors. Repeated heating and cooling of the brake disk or brake rotor resulting in extreme temperature variations can additionally result in the lateral warping of the brake disk or brake rotor.

A worn or warped brake disk or brake rotor may be resurfaced by cutting or grinding to provide a uniform smooth brake friction pad contact surface, if sufficient brake disk or brake rotor material remains, to provide an adequate braking surface without compromising the structural integrity of the vehicle braking system. However, once a brake disk or brake rotor has been worn below a minimum safe thickness, it is unable to safely dissipate the heat generated by a brake application, and must be replaced.

To provide for a uniform surface, any abnormalities in the brake disk or brake rotor, such as a lateral warping must be detected and removed during the resurfacing procedures. An additional source of lateral warping defects in a brake rotor or brake disk is over tightened attachment bolts or an uneven mounting surface onto which the brake disk or brake rotor is secured in the vehicle wheel assembly. If the brake disk or brake rotor is removed from the vehicle wheel assembly for a resurfacing operation on a fixed or “bench” brake lathe any abnormalities or defects resulting from the mounting of the brake disk or brake rotor to the vehicle wheel assembly may not be accurately identified or corrected during the resurfacing procedure. Accordingly, a variety of brake resurfacing machines or brake lathes have been developed to resurface brake disks and brake rotors while they remain mounted to the vehicle wheel assembly.

Brake resurfacing machines or brake lathes configured to resurface brake disks and brake rotors mounted to a vehicle wheel assembly are commonly referred to as on-car brake lathes. One example of an on-car brake lathe is the OCL-400 brake lathe sold by Hunter Engineering Co. of Bridgeton, Mo. By eliminating the need to remove the brake disk or brake rotor from the vehicle wheel assembly, the overall efficiency of the resurfacing procedure is improved, and the chances for operator induced error are reduced.

Traditionally, on-car and bench brake lathes, such as the BL501/BL505 off-car brake lathe sold by Hunter Engineering Co. of Bridgeton, Mo., utilize motors or drive systems configured for operation at a fixed spindle RPM and feed rate. During rotor cutting or resurfacing, a resonance or vibration, commonly referred to as “chatter”, can develop between the rotor cutting tools and the rotor surface, resulting at best in an uneven resurfacing of the brake rotor, or at worst, in severe damage to the rotor surface or rotor cutting tools themselves. Accordingly, different types of cutting tools of various geometries, materials and coatings are used for “rough” cutting the brake rotor and for “finish” cutting the brake rotor. It is accepted knowledge that a tool with a small nose radius will be less susceptible to chatter. This allows the small radius tool to be useful for removing large amounts of material. The drawback is that the small radius tool is likely to leave a surface finish that is rougher than desired. A tool with a large nose radius is more likely to chatter so it is typically not used to remove large amounts of material. The large radius tool has the advantage of producing a smoother, more desirable surface finish. However, frequent changing of the cutting tools to accommodate different applications is time consuming and can result in misplaced cutting tools. Therefore, there is a need for a tool holder that can accommodate multiple cutting tools so that a single cutting tool will not require frequent removal and replacement.

### BRIEF SUMMARY OF THE INVENTION

A cutting tool for a brake lathe for machining automobile brake rotors including an adjustable cutting head. The cutting tool defines a first side and an opposite, second side. The cutting tool also defines a first end and a second end. The first side adjacent the first end defines a mounting surface for removably mounting a first cutting tip. The first side adjacent the second end also defines a mounting surface for removably mounting a second cutting tip. The cutting tool is configured to be mounted in the adjustable head such that the first cutting tip is positioned to machine the automobile brake rotor or the cutting tool may be mounted such that the second cutting tip is positioned to machine the automobile brake rotor.

In an alternate embodiment the tool holder is set up to show that more than one insert is in contact with the workpiece at the same time. This allows the use of a small radius insert to make the preliminary cut for the purposes of removing large amounts of material and the simultaneous use of a large radius insert to provide the desired smooth surface finish.

The foregoing and other aspects of the invention, as well as presently preferred embodiments thereof, will become more apparent from the reading of the following detailed description in connection with the accompanying drawings.

### BRIEF DESCRIPTION OF THE SEVERAL VIEWS OF THE DRAWINGS

In the accompanying drawings which form part of the specification:

FIG. 1 is a perspective view of a vehicle brake lathe secured to a transport trolley according to the prior art;

FIG. 2 is a perspective view of the vehicle brake lathe of FIG. 1, without the transport trolley according to the prior art;

FIG. 3 is a view of a control panel of a vehicle brake lathe according to the prior art;

FIG. 4 is a perspective view of an adjustable cutting head according to an embodiment of the present invention;

FIG. 5 is a top plan view of an adjustable cutting head according to an embodiment of the present invention;

FIG. 6 is a top plan view of a cutting tool according to an embodiment of the present invention;

FIG. 7 is a bottom plan view of a cutting tool according to an embodiment of the present invention;

FIG. 9 is a top plan view of an adjustable cutting head according to an embodiment of the present invention;

FIG. 8 is a perspective view of a cutting tool according to another embodiment of the present invention;

FIG. 10 is a perspective view of a cutting tool according to another embodiment of the present invention;

FIG. 11 is a top view of a cutting tool according to yet another embodiment of the present invention; and

FIG. 12 is a perspective view of a cutting tool according to yet another embodiment of the present invention.

FIG. 13 is a top view of a cutting tool according to yet another embodiment of the present invention; and

FIG. 14 if a top view of a cutting tool of the present invention used to machine a brake drum.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

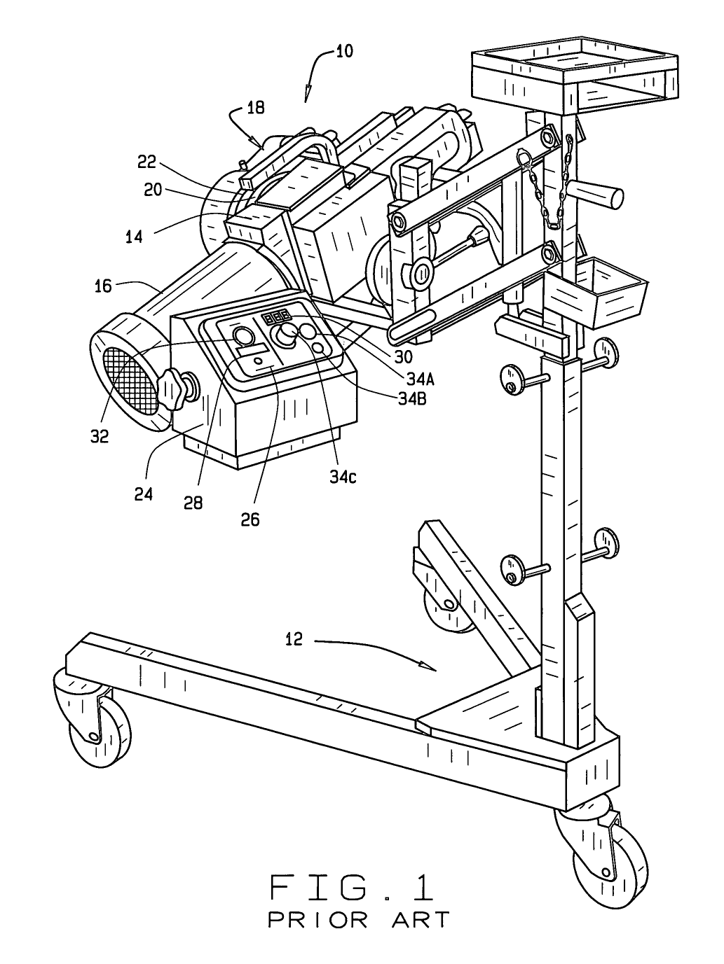

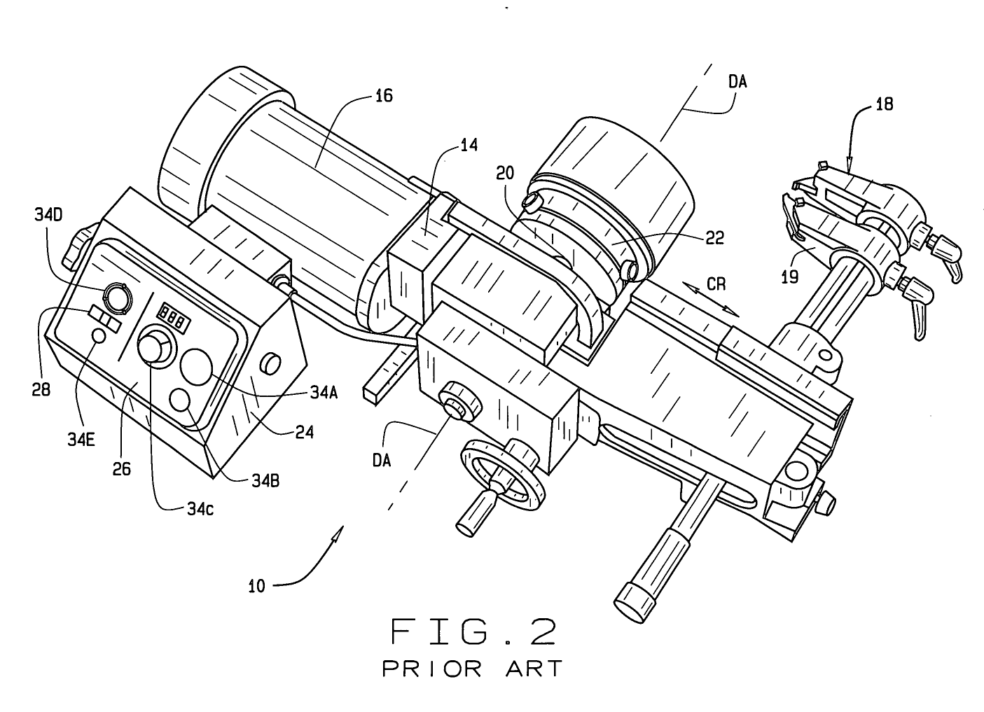

Referring to FIGS. 1 and 2, an on-car brake lathe 10 is shown mounted to a transport trolley 12 for positioning adjacent a vehicle to be worked on (not shown). The on-car brake lathe 10 includes a support structure 14, onto which is mounted a drive system. The drive system preferably includes a spindle motor 16, an adjustable cutting head 18, and an output spindle 20. The spindle motor 16 is coupled to the output spindle 20 through a conventional drive mechanism (not shown) contained within the support structure 14 to rotate the output spindle 20 about a drive axis DA, and to linearly feed the cutting head 18 through a predetermined cutting range CR. An aligning joint 22 is secured to the output spindle 20, concentric with the drive axis DA, adapted to couple the output spindle 20 to a vehicle wheel hub or brake assembly.

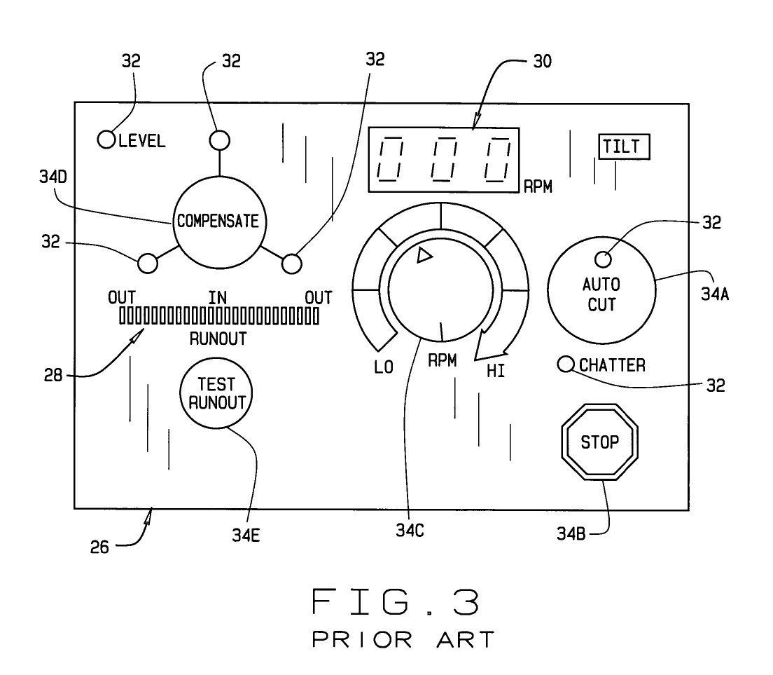

Additionally included on the support structure 14 is an electrical enclosure 24. An operator interface 26 is mounted to the electrical enclosure 24. The operator interface 26, shown in FIG. 3, preferably includes at least a bar graph LED display 28 and a numerical LED display 30, and may optionally include one or more additional visual display elements 32 configured to provide the operator with information associated with the operation of the on-car brake lathe 10. For example, multiple visual display elements 32 in the form of single LED lights may be disposed on the operator interface 26 to assist an operator in performing a runout compensation procedure when coupling the on-car brake lathe 10 with a vehicle brake assembly, or to indicate the presence of a chatter condition during a resurfacing procedure.

Operator input controls 34 are additionally included on the operator interface 26. The operator input controls 34 preferably include at least a start button 34A, a stop button 34B, a spindle speed control knob 34C, a compensation button 34D, and a runout test button 34E.

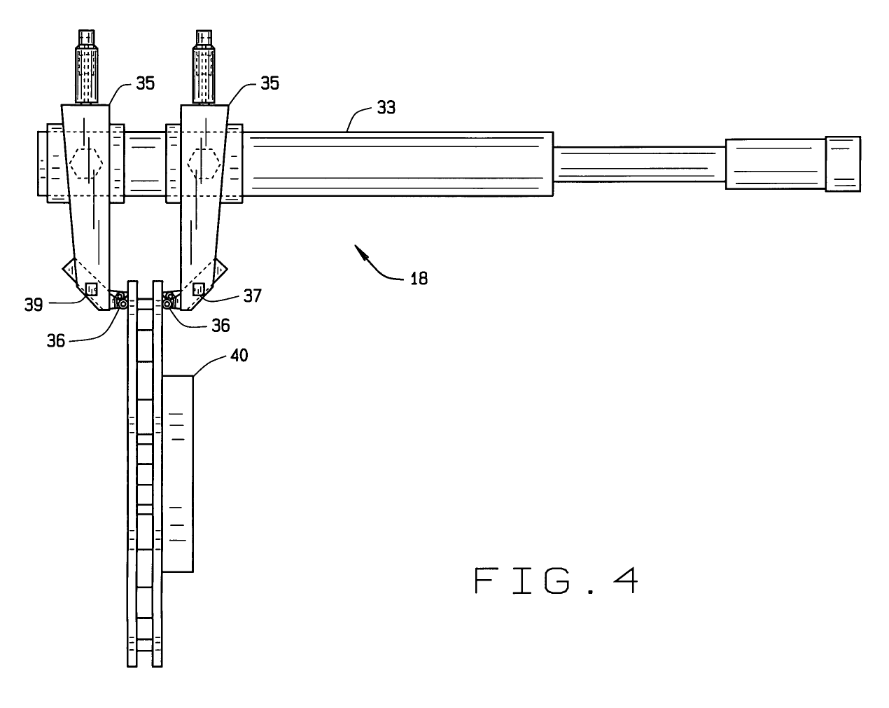

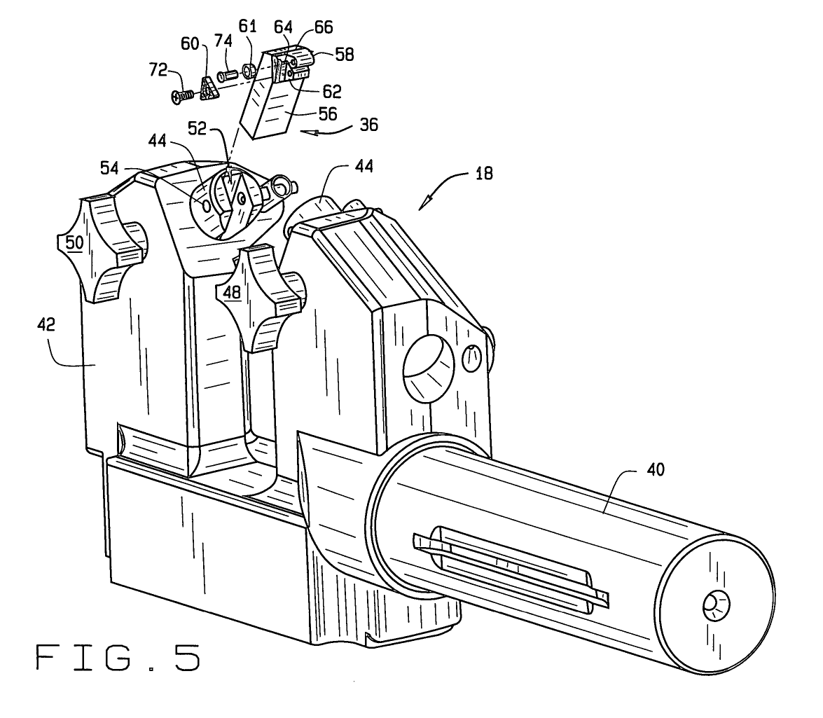

Referring to FIG. 4, the cutting head 18 is shown in greater detail. The cutting head 18 comprises a bar 33 having mounted thereon two moveable arms 35 that may be moved back and forward along the bar 33 and locked in position thereon. A user of the lathe 10 can adjust the arms 35 to remove material from a brake rotor 46 with a cutting tool 36. Set screws 37 and 39 are tightened before machining of the brake rotor 46 in order to firmly secure the cutting tool 36.

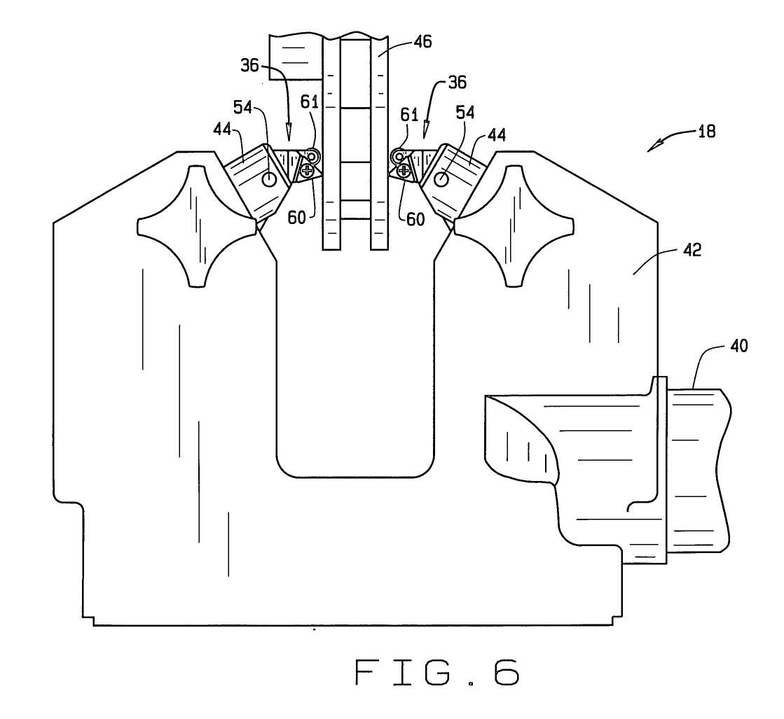

Referring now to FIGS. 5 and 6 there is shown the adjustable cutting head 18 according to an embodiment of the present invention for use on a bench-type brake lathe rather than an on-car brake lathe as described above. The cutting head 18 comprises fixture bar 40 and a U-shaped tool holder 42. On either side of the U-shaped tool holder 42, bores are defined into which are positioned tool plungers 44. A user of the lathe 10 can adjust the tool plungers 44 to extend out of the bores by varying distances to remove material from a brake rotor 46. Set screws 48 and 50 are tightened before machining of the brake rotor 46 in order to firmly secure the plungers 44 in the proper position. Machining or machining operations is defined herein as a cutting tip in contact with a surface of a workpiece, such as an automobile brake rotor.

Each of the plungers 44 further defines a central opening 52 into which a cutting tool 36 is placed. Each cutting tool 36 is held in position within the central opening 52 by a fastener 54.

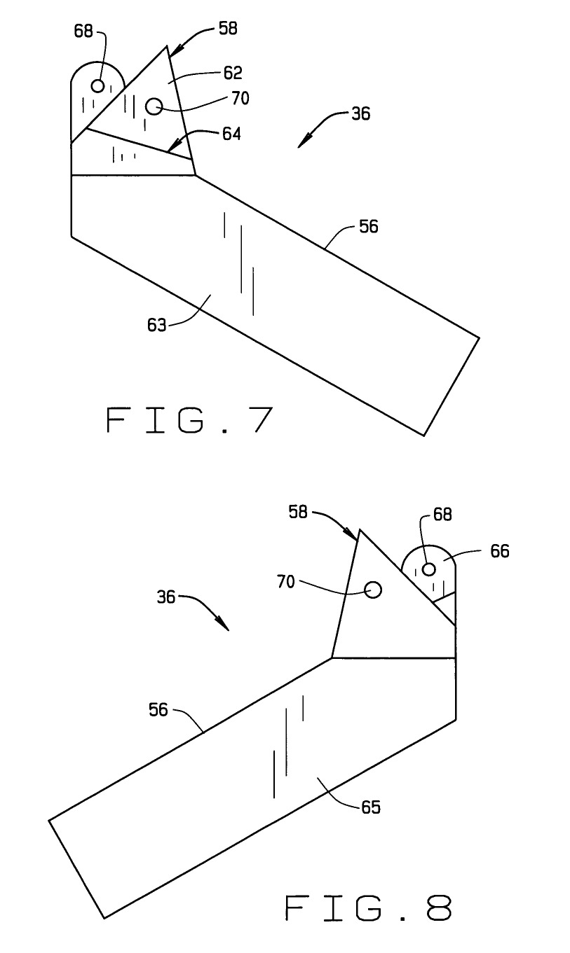

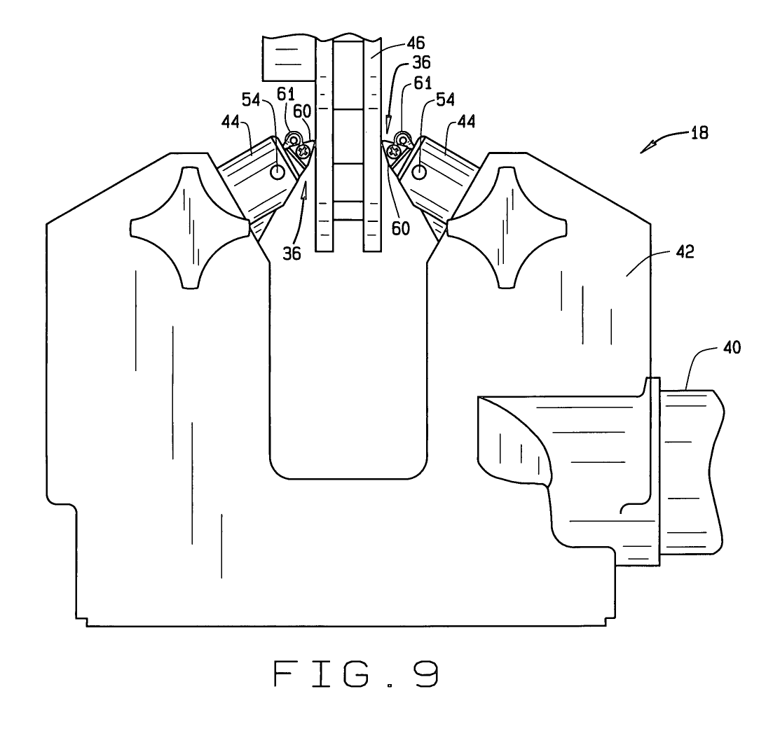

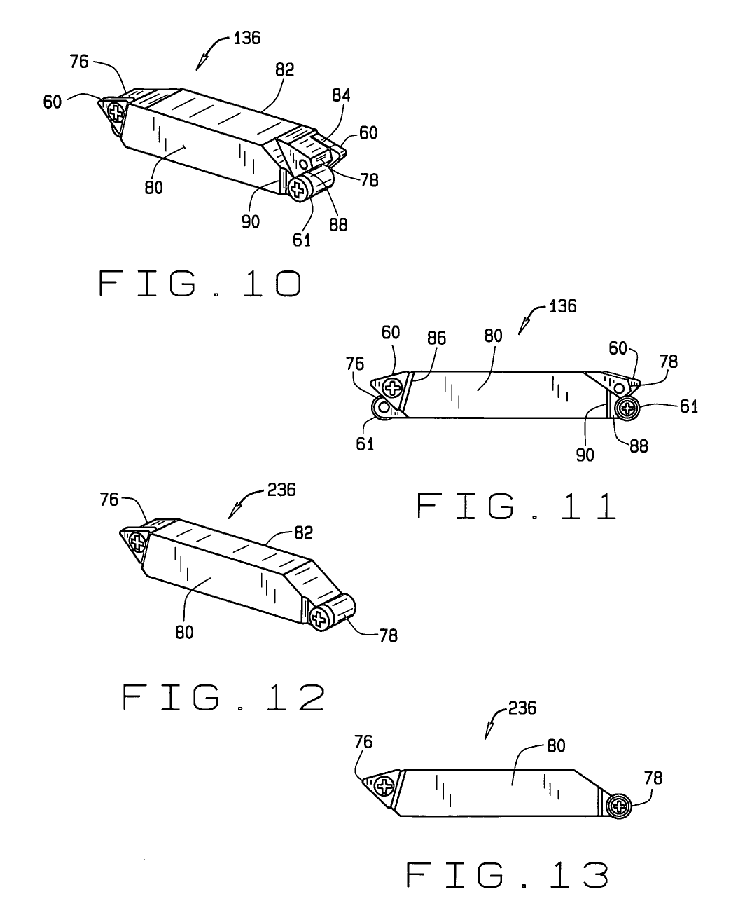

In FIGS. 7 and 8, a cutting tool 36 according to the present invention is shown.

The cutting tool 36 has a rectilinear body portion 56 and an offset end 58. The offset end 58 has first and second removable cutting tips 60 and 61 that are removably mounted thereto. As shown in FIG. 7, the offset end 58 of the cutting tool 36 further defines a first recessed surface 62 on a first side 63 of the cutting tool 36 that forms a shoulder 64 for holding a triangular removable cutting tip 60 in place. As shown in FIG. 8, the offset end 58 further defines a second recessed surface 66 on a second, opposite side 65 of the cutting tool 36 upon which a circular cutting tip 61 is mounted. Each surface 62 and 66 further includes a threaded bore 68 and 70 therethrough for mounting of the cutting tips 60 and 61 to the first and second recessed surfaces 62 and 66 with fasteners 72 and 74. It should be noted that two triangular inserts may be mounted in the same tool holder. One of the triangular inserts may have a small nose radius, of approximately 0.015″ and be most useful as a roughing tool to remove large amounts of material without chatter. The second insert can be triangular as well but with a substantially larger nose radius, for example approximately 0.060″, which is better suited to producing a smooth surface finish.

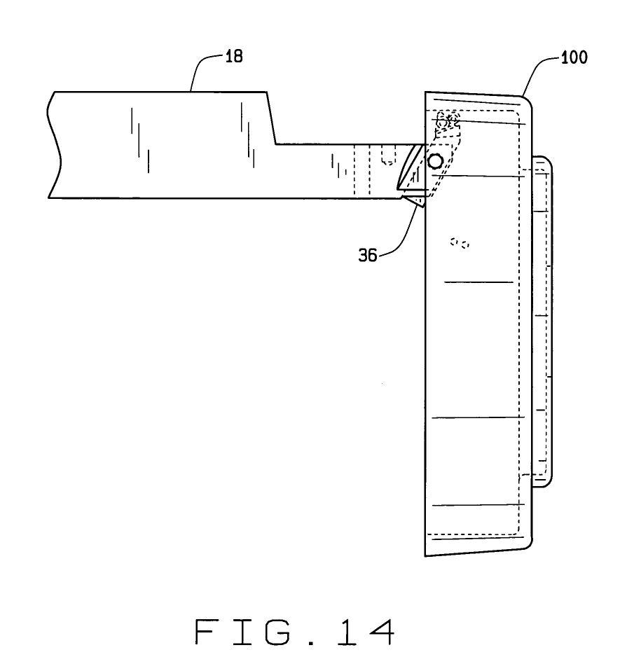

It can be seen that the cutting tools 36 may be inserted in the lathe 10 in one orientation, as shown in FIG. 6, such that the offset 58 of the cutting tool 36 extends toward the outer diameter of the brake rotor 46 and the triangular cutting tip 60 is on top (with respect to FIG. 7). In this orientation, the triangular cutting tip 60 contacts the rotor 46 and performs the machining. Referring to FIG. 9, the cutting tools 36 may be exchanged side-to-side such that the offsets 58 of the cutting tools 36 extend toward the center of the brake rotor 46.

Moreover, the cutting tool 36 can be rotated and exchanged side-to-side such that the circular cutting bit 61 is on top of the cutting tool 36 and only the circular cutting bit 61 comes into contact with the brake rotor 46 to machine the brake rotor 46.

In an alternative embodiment shown in FIGS. 10 and 11, a cutting tool 136 is provided that has a first end 76 and a second end 78, each end having a first side 80 and a second side 82. The first side 80 of each end 76 and 78 defines a first recessed portion 84 and a shoulder 86. The second side 82 of each end 76 and 78 defines a second recessed portion 88 and a shoulder 90. The first recessed portions 84 can accommodate a triangular cutting bit 60 and the second recessed portion can accommodate a circular cutting bit 61. The cutting bits 60 and 61 are attached to the cutting tool 36 by fasteners as in the first embodiment. In this manner an operator can easily switch between different cutting bits 60 and 61 by removing the cutting tools and either rotating the cutting tool 36 and replacing it in the lathe, swapping it end for end and replacing it in the lathe, or both, to utilize a desired cutting bit.

In yet another embodiment of the present invention of FIGS. 12 and 13, a cutting tool 236 is shown that has a first and second recessed portion and a shoulder at opposite ends of the tool on only a first side 80 of the cutting tool. Therefore, this embodiment is similar to the embodiment of FIGS. 10 and 11 except that it utilizes only a first side of the tool. While this embodiment has two fewer recessed portions for holding cutting bits 60 and 61, it is also simpler and less costly to produce.

While the present invention has been described above with respect machining automobile rotors, it will be understood by one of ordinary skill in the art that it further has application to machining brake drums. In this regard and referring to FIG. 14, a cutting head 18 is shown having a cutting tool 36 for machining an interior surface 100 of a brake drum 102.

While the above embodiments have been described with respect to using a combination of circular and triangular cutting bits, one of ordinary skill in the art would readily understand that any combination of bits may be accommodated by the cutting tool or that a single type of bit may be used many times on the cutting tool and the tool rotated as each bit becomes dull.

While the present invention has been described in terms of an on car brake lathe it will be understood by one of ordinary skill in the art that the present invention applies equally to a bench brake lathe as well.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A cutting tool for a brake lathe wherein
the cutting tool has a plurality of mounting surfaces for mounting more than one cutting tip to the cutting tool.

2. The cutting tool of claim 1 defining first and second sides, each of said sides having first and second ends, the first side adjacent the first end defining a first mounting surface for removably mounting a first cutting tip and the first side adjacent the second end also defining a second mounting surface for removably mounting a second cutting tip, wherein the cutting tool is configured to be mounted in the adjustable head in a first position such that the first cutting tip is positioned for machining operations and wherein the cutting tool may be mounted in the adjustable head in a second position such that the second cutting tip is positioned for machining operations.

3. The cutting tool of claim 1 wherein the cutting tool has a rectilinear body portion and an offset end.

4. The cutting tool of claim 2 wherein the cutting tool is configured to accept a triangular cutting tip at the first end and a circular cutting tip at the second end.

5. The cutting tool of claim 2 wherein the cutting tool is configured to accept a two triangular cutting tips at the first and second ends.

6. The cutting tool of claim 2 wherein the cutting tool is configured to accept a two circular cutting tips at the first and second ends.

7. The cutting tool of claim 2 wherein the second side adjacent the first end defines a mounting surface for removably mounting a third cutting tip and the second side adjacent the second end defines a mounting surface for removably mounting a fourth cutting tip, wherein the cutting tool is configured to be mounted in the adjustable head in a third position such that the third cutting tip may be positioned for machining operations and wherein the cutting tool may be mounted in the adjustable head in a fourth position such that the fourth cutting tip is positioned for machining operations.

8. The cutting tool of claim 2 wherein each of said mounting surfaces are characterized by a recessed surface onto which the cutting tip is mounted.

9. The cutting tool of claim 1 defining first and second sides, each of said sides having first and second ends, the first side adjacent the first end defining a mounting surface for removably mounting a first cutting tip and the second side adjacent the first end also defining a mounting surface for removably mounting a second cutting tip, wherein the cutting tool is configured to be mounted in the adjustable head in a first position such that the first cutting tip is positioned for machining operations.

10. The cutting tool of claim 8 wherein each of said cutting tools has a rectilinear body portion and an offset end.

11. The cutting tool of claim 8 wherein each of said cutting tools is configured to accept a triangular cutting tip on the first side and a circular cutting tip on the second side.

12. The cutting tool of claim 1 wherein the cutting tool has a rectilinear body portion and an offset end.

13. The cutting tool of claim 2 wherein the cutting tool is configured to accept a triangular cutting tip at the first end and a circular cutting tip at the second end.

14. The cutting tool of claim 8 wherein the first cutting tip is a triangular cutting tip and the second cutting tip is a circular cutting tip and wherein the first side adjacent the second end defines a mounting surface for removably mounting a third, triangular cutting tip and the second side adjacent the second end defines a mounting surface for removably mounting a fourth, circular cutting tip, wherein the cutting tool is configured to be mounted in the adjustable head in a third position such that the third cutting tip may be for machining operations and wherein the cutting tool may be mounted such that the fourth cutting tip is positioned for machining operations.

15. The cutting tool of claim 8 wherein each of the mounting surfaces are characterized by a recessed surface onto which the cutting tip is mounted.

16. A cutting tool for a brake lathe for machining automobile brake rotors and drums comprising:
the cutting tool defining a first side and an opposite, second side and a first end and an opposite, second end, wherein the first end is offset from a central axis of a body of the cutting tool;
wherein the first side adjacent the first end defines a first mounting surface for removable mounting a first cutting tip and the second side adjacent the first end defines a second mounting surface for removably mounting a second cutting tip, wherein the cutting tool is configured to be mounted in the adjustable head in a position such that the first cutting tip and the second cutting tip are each positioned for simultaneous machining operation.

17. The cutting tool of claim 16 wherein adjustable plungers are disposed within the cutting head to allow a user to adjust the cutting tips closer or farther from the automobile brake rotor to be machined and each plunger further defines a central opening into which the cutting tool is mounted.

18. The cutting tool of claim 16 wherein the first cutting tip a small nose radius for rough machining operation and the second cutting tip has a large nose radius for finishing operations.

19. The cutting tool of claim 16 wherein the cutting tool has a rectilinear body portion.

20. The cutting tool of claim 16 wherein the first side adjacent the second end defines a mounting surface for removably mounting a third cutting tip and the second side adjacent the second end defines a mounting surface for removably mounting a fourth cutting tip, wherein the cutting tool is configured to be mounted in the adjustable head in a third position such that the third cutting tip is positioned for machining operations and the cutting tool is configured mounted in the adjustable head in a fourth position such that that fourth cutting tip is positioned for machining operations.
